(19) United States
(12) Patent Application Publication
(10) Pub. No.: US 2022/0253571 A1
(43) Pub. Date: Aug. 11, 2022

(54) METHOD AND SYSTEM FOR ESTIMATING HYDRAULIC STATE OF STEAM HEATING NETWORK DURING DYNAMIC OPERATION

(71) Applicant: TSINGHUA UNIVERSITY, Beijing (CN)

(72) Inventors: Hongbin SUN, Beijing (CN); Tian XIA, Beijing (CN); Binbin CHEN, Beijing (CN); Lijuan DUAN, Beijing (CN); Qinglai GUO, Beijing (CN); Bin WANG, Beijing (CN)

(21) Appl. No.: 17/446,650

(22) Filed: Sep. 1, 2021

(30) Foreign Application Priority Data
Feb. 1, 2021 (CN) 2021101364289

(51) Int. Cl. G06F 30/20

(52) U.S. Cl. CPC G06F 30/20; G06F 2111/10

(57) ABSTRACT

A method for estimating a hydraulic state of a steam heating network during dynamic operation, the method comprising acquiring parameters, the parameters including steam flow G, steam flow velocity ν, steam density ρ, steam pressure p, pipeline inner diameter D, pipeline inclination angle α, a number of nodes N, and a number of branches M of each pipeline; inputting the parameters into a state estimation model constructed; and determining a hydraulic state by the state estimation model according to the parameters. The method and system for estimating a hydraulic state of a steam heating network during dynamic operation provided herein can adapt to dynamic working conditions of a steam network at project site, precisely estimate a hydraulic operation state of a steam network, and improve collection quality of hydraulic operation data so as to ensure that the network is in a safe operation state.

### FIELD OF TECHNOLOGY

The present invention relates to the field of operational control of a comprehensive energy system, in particular to a method and system for estimating a hydraulic state of a steam heating network during dynamic operation.

### BACKGROUND

With the characteristic of high-energy density, steam is widely used in industries such as food and manufacture, and the corresponding energy consumption accounts for a substantial part of the total energy consumption of the national economy. To fully share steam transmission infrastructures, related factories are often clustered into an industrial park and established a steam network. State estimation is essential for the steam network to ensure safe operation and high-quality data collection. Among which hydraulic state estimation closely related to network safety is particularly important. A heating network is a crucial part of the comprehensive energy system, and at present, it has been found in many researches that the permeability and energy utilization efficiency of new energy are improved by using the flexibility of a heating network in an energy network. Hot water is considered as a heating medium of the heating network in all these studies, while high temperature and high pressure steam is selected as a heating medium of the heating network in many industrial parks. Compared with a hot water pipe network, a steam pipe network is more complicated in transmission process, which becomes an obstacle to performing combined analysis and optimization on a comprehensive energy system by means of flexibility of the steam pipe network.

Currently, studies on a method for estimating a hydraulic state of a steam network are generally based on steady state operating conditions. In fact, due to the characteristic of a non-real time balance between supply and demand, a steam network at project site is in a dynamic operating condition at most of time, i.e., steam flow and pressure fluctuate with time. At this time, hydraulic state estimation based on a steady state equation will lead to larger estimation errors.

Therefore, problems, such as larger estimation errors caused by the hydraulic state estimation based on a steady state equation, have increasingly become technical problems to be solved urgently.

### SUMMARY

In the view of above problems, the present invention provides a method and system for estimating a hydraulic state of a steam heating network during dynamic operation. Based on a hydrodynamic equation describing dynamic characteristics of steam, the present invention establishes a model for estimating a hydraulic state of a steam heating network during dynamic operation and puts forward a corresponding solving method, thereby improving accuracy of hydraulic state estimation and achieving more effective monitoring of operational states of a steam network.

The present invention provides a method for estimating a hydraulic state of a steam heating network during dynamic operation, the method comprising:

acquiring parameters, the parameters including steam flow G, steam flow velocity ν, steam density ρ, steam pressure p, pipeline inner diameter D, pipeline inclination angle α, a number of nodes N, and a number of branches M of each pipeline;
inputting the parameters into a state estimation model; and
determining a hydraulic state by the state estimation model according to the parameters.

Further, a specific construction method of the state estimation model comprises:

establishing a branch equation of steam heating pipelines;
establishing a node equation of junctions of the different steam heating pipelines; and
establishing a hydraulic state estimation model of the steam heating network during dynamic operation according to the branch equation and the node equation.

Further, the determining a hydraulic state by the state estimation model according to the parameters specifically comprises:

solving the hydraulic state estimation model of the steam heating network during dynamic operation established according to the branch equation and the node equation;
calculating steam flow, steam flow velocity, steam density, and steam pressure state for all pipelines according to the state estimation model.

Further, the establishing a branch equation of steam heating pipelines includes a specific process of:

simplifying steam within the steam heating pipelines to one-dimensional flow along a direction of the pipelines, and establishing a mass-conservation equation thereof:

$$\frac{\partial ρ}{\partial τ} + \frac{\partial ρ v}{\partial x} = 0$$

simplifying steam within the steam heating pipelines to one-dimensional flow along a direction of the pipelines, and establishing a mass-conservation equation thereof:

$$\frac{\partial ρ}{\partial τ} + \frac{\partial ρ v}{\partial x} = 0$$

wherein ρ is steam density, ν is steam flow velocity, τ represents time dimension, and x represents one-dimensional space dimension along the direction of the steam heating pipelines;
simplifying steam within the steam heating pipelines to one-dimensional flow along the direction of the pipelines, and establishing a momentum conservation equation thereof:

$$\frac{\partial ρ v}{\partial t} + \frac{\partial p}{\partial x} + \frac{λ ρ {v}^{2}}{2 D} + ρ g sin α = 0$$

wherein p is steam pressure, λ is pipeline friction coefficient, D is pipeline inner diameter, g is acceleration of gravity, α is pipeline inclination angle, and t is time; establishing a state equation of steam:

pᵢ=ρᵢRTᵢ

pⱼ=ρⱼRTⱼ

wherein pᵢ is steam pressure at node i, pⱼ is steam pressure at node j, ρᵢ is steam density at node i, ρⱼ is steam density at node j, R is a gas constant fitted by steam nearby operation conditions, Tᵢ is a measured temperature of steam at node i, and Tⱼ is a measured temperature of steam at node j; and
establishing a flow equation of steam within the pipelines:

$${G}_{i j} = \frac{π {D}^{2}}{4} {ρ}_{i} {v}_{i} \\ {G}_{j i} = \frac{π {D}^{2}}{4} {ρ}_{j} {v}_{j}$$

wherein Gᵢⱼ represents steam flow at a head end of branch ij, Gⱼᵢ represents steam flow at a distal end of branch ij, νᵢ is steam flow velocity at node i, and νⱼ is steam flow velocity at node j.

Further, the establishing a node equation of junctions of the different steam heating pipelines is:

$${\sum }_{k ∈ {S}_{i}^{+}} {G}_{k i} - {\sum }_{l ∈ {S}_{i}^{-}} {G}_{il} = 0$$

wherein Gₖᵢ represents steam flow from branch ki into node i, Gᵢₗ represents steam flow from branch il into node i, Sᵢ⁺ is a branch set flowing into node i, and Sᵢ⁻ is a branch set flowing out of node i.

Further, the establishing a hydraulic state estimation model of a steam heating network during dynamic operation according to the branch equation and the node equation specifically comprises:

establishing an objective function of a hydraulic state estimation model of a steam heating network with a purpose of minimizing mean square error considering covariance:

min(x−\hat{x})^{T}W⁻¹(x−\hat{x})

wherein W represents a covariance matrix consisting of measurement values, x represents a vector consisting of all measurement variables, and \hat{x} represents a vector consisting of all measurement variables:

x=[p₁, . . . ,p_{N},G₁, . . . ,G_{M}]^{T}

\hat{x}=[\hat{p}₁, . . . ,\hat{p}_{N},Ĝ₁, . . . ,Ĝ_{M}]^{T}

wherein p is actual steam pressure, N is a number of nodes, M is a number of branches, p₁ is actual steam pressure at node 1, p_{N} is actual steam pressure at node N, G₁ is flow of branch 1, G_{M} is flow of branch M, \hat{p}₁ is a sensor sampling value of steam pressure at node 1, \hat{p}_{N} is a sensor sampling value of steam pressure at node N, Ĝ₁ is a sensor sampling value of flow of branch 1, and Ĝ_{M} is a sensor sampling value of branch M.

Further, the solving the hydraulic state estimation model of a steam heating network during dynamic operation established according to the branch equation and the node equation specifically comprises:

S1: fixing all steam flow velocity variables to solve a hydraulic state estimation model of a steam heating network during dynamic operation as a linear programming problem;
S2: fixing steam flow variables solved in S1 to solve a hydraulic state estimation model of a steam heating network during dynamic operation as a linear programming problem; and
S3: checking convergence, solving convergence when a norm of the difference between steam flow inversely deduced from steam flow velocity obtained in S2 according to the steam flow equation and steam flow fixed in advance in S2 is smaller than the given threshold;
returning to S1-S2 to continue iteration when a norm of the difference between steam flow inversely deduced from steam flow velocity obtained in S2 according to the steam flow equation and steam flow fixed in advance in S2 is greater than or equal to the given threshold.

The invention further provides a system for estimating a hydraulic state of a steam heating network during dynamic operation, the system comprising:

an acquiring unit for acquiring parameters, the parameters including steam flow G, steam flow velocity ν, steam density ρ, steam pressure p, pipeline inner diameter D, pipeline inclination angle α, a number of nodes N, and a number of branches M of each pipeline; an inputting unit for inputting the parameters into a state estimation model constructed thereby, and an estimating unit for determining a hydraulic state by the state estimation model according to the parameters.

Further, the state estimation model in the estimating unit is specifically constructed by:

establishing a branch equation of steam heating pipelines;
establishing a node equation of junctions of the different steam heating pipelines; and
establishing a hydraulic state estimation model of a steam heating network during dynamic operation according to the branch equation and the node equation.

Further, the estimating unit for determining a hydraulic state by a state estimation model according to the parameters specifically comprises:

solving the hydraulic state estimation model of a steam heating network during dynamic operation established according to the branch equation and the node equation;
calculating steam flow, steam flow velocity, steam density, and steam pressure state of all pipelines according to the state estimation model.

Further, the establishing a branch equation of steam heating pipelines in the estimating unit specifically comprises:

simplifying steam within the steam heating pipelines to one-dimensional flow along a direction of the pipelines, and establishing a mass-conservation equation thereof:

$$\frac{\partial ρ}{\partial τ} + \frac{\partial ρ v}{\partial x} = 0$$

wherein ρ is steam density, ν is steam flow velocity, τ represents time dimension, and x represents one-dimensional space dimension along a direction of the steam heating pipelines;
simplifying steam within the steam heating pipelines to one-dimensional flow along a direction of the pipelines, and establishing a momentum conservation equation thereof:

$$\frac{\partial ρ v}{\partial t} + \frac{\partial p}{\partial x} + \frac{λ ρ {v}^{2}}{2 D} + ρ g sin α = 0$$

wherein p is steam pressure, λ is pipeline friction coefficient, D is pipeline inner diameter, g is acceleration of gravity, α is pipeline inclination angle, and t is time;
establishing a state equation of steam:

pᵢ=ρᵢRTᵢ

pⱼ=ρⱼRTⱼ

wherein pᵢ is steam pressure at node i, pⱼ is steam pressure at node j, ρᵢ is steam density at node i, ρⱼ is steam density at node j, R is a gas constant fitted by steam nearby operation conditions, Tᵢ is a measured temperature of steam at node i, and Tⱼ is a measured temperature of steam at node j; and
establishing a flow equation of steam within the pipelines:

$${G}_{i j} = \frac{π {D}^{2}}{4} {ρ}_{i} {v}_{i}$$

$${G}_{j i} = \frac{ {D}^{2}}{4} {ρ}_{j} {v}_{j}$$

wherein Gᵢⱼ represents steam flow at a head end of branch ij, Gⱼᵢ represents steam flow at a distal end of branch ij, νᵢ is steam flow velocity at node i, and νⱼ is steam flow velocity at node j.

Further, the node equation of junctions of the different steam heating pipelines established by the estimating unit is:

$${\sum }_{k ∈ {S}_{i}^{+}} {G}_{k i} - {\sum }_{l ∈ {S}_{i}^{-}} {G}_{il} = 0$$

wherein Gₖᵢ represents steam flow from branch ki into node i, Gᵢₗ represents steam flow from branch il into node i, Sᵢ⁺ is a branch set flowing into node i, and Sᵢ⁻ is a branch set flowing out of node i.

Further, a process that the estimating unit is used for establishing a hydraulic state estimation model of a steam heating network during dynamic operation according to the branch equation and the node equation comprises:

establishing an objective function of a hydraulic state estimation model of a steam heating network with a purpose of minimizing mean square error considering covariance:

min(x−\hat{x})^{T}W⁻¹(x−\hat{x})

wherein W represents a covariance matrix consisting of measurement values, x represents a vector consisting of all measurement variables, and \hat{x} represents a vector consisting of all measurement variables:

x=[p₁, . . . ,p_{N},G₁, . . . ,G_{M}]^{T}

\hat{x}=[\hat{p}₁, . . . ,\hat{p}_{N},Ĝ₁, . . . ,Ĝ_{M}]^{T}

wherein p is actual steam pressure, N is a number of nodes, M is a number of branches, p₁ is actual steam pressure at node 1, P_{N} is actual steam pressure at node N, G₁ is flow of branch 1, G_{M} is flow of branch M, \hat{p}₁ is a sensor sampling value of steam pressure at node 1, \hat{p}_{N} is a sensor sampling value of steam pressure at node N, Ĝ₁ is a sensor sampling value of flow of branch 1, and Ĝ_{M} is a sensor sampling value of branch M.

Further, the solving the hydraulic state estimation model of a steam heating network during dynamic operation established according to the branch equation and the node equation by a hill-climbing method specifically comprises:

S1: fixing all steam flow velocity variables to solve a hydraulic state estimation model of a steam heating network during dynamic operation as a linear programming problem;
S2: fixing steam flow variables solved in S1 to solve a hydraulic state estimation model of a steam heating network during dynamic operation as a linear programming problem; and
S3: checking convergence, solving convergence when a norm of the difference between steam flow inversely deduced from steam flow velocity obtained in S2 according to the steam flow equation and steam flow fixed in advance in S2 is smaller than the given threshold; returning to S1-S2 to continue iteration when a norm of the difference between steam flow inversely deduced from steam flow velocity obtained in S2 according to the steam flow equation and steam flow fixed in advance in S2 is greater than or equal to the given threshold.

The method and system for estimating a hydraulic state of a steam heating network during dynamic operation provided herein can adapt to dynamic working conditions of a steam network at project site, precisely estimate a hydraulic operation state of a steam network, and improve collection quality of hydraulic operation data so as to ensure that the network is in a safe operation state. Other features and advantages of the present invention will be set forth in the subsequent description, and partly become apparent from the description, or become acknowledged by implementing the present invention. The purpose and other advantages of the present invention can be realized and acquired via the structure indicated in the description, claims, and accompanying figures.

### BRIEF DESCRIPTION OF THE DRAWINGS

To clearly explain the technical solution of examples of the present invention or the prior art, described below is a brief introduction to accompanying figures required for describing examples or the prior art. Apparently, the accompanying figures described hereinafter are some examples of the invention, whereby a person of ordinary skill in the art can further obtain other figures without any ingenuity.

FIG. 1 shows a flow chart of a method for estimating a hydraulic state of a steam heating network during dynamic operation according to an example of the present invention.

### DESCRIPTION OF THE EMBODIMENTS

To clarify the objective, technical solutions, and advantages of examples of the present invention, the technical solutions in examples of the present invention will be described clearly and completely with reference to the accompanying figures in examples of the present invention. Apparently, the described examples are part of examples of the present invention, rather than all examples. Based on examples of the present invention, all other examples acquired by a person of ordinary skill in the art without any ingenuity shall fall within the protection scope of the present invention.

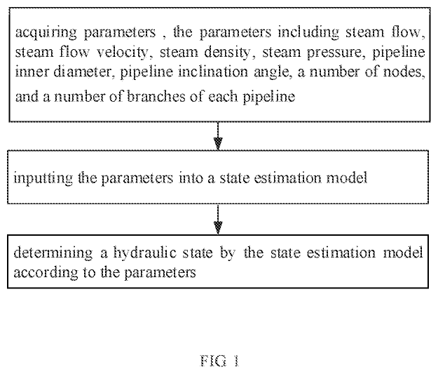

The present invention provides a method for estimating a hydraulic state of a steam heating network during dynamic operation. As shown in FIG. 1, FIG. 1 shows a flow chart of a method for estimating a hydraulic state of a steam heating network during dynamic operation according to an example of the present invention, the method specifically comprising:

acquiring parameters, the parameters including steam flow G, steam flow velocity ν, steam density ρ, steam pressure p, pipeline inner diameter D, pipeline inclination angle α, a number of nodes N, and a number of branches M of each pipeline, the parameters being collected with a sensor;
inputting the parameters into a state estimation model; and
determining a hydraulic state by the state estimation model according to the parameters.

Specifically, a construction method of the state estimation model comprises: establishing a branch equation of steam heating pipelines; establishing a node equation of junctions of the different steam heating pipelines; and establishing a hydraulic state estimation model of a steam heating network during dynamic operation according to the branch equation and the node equation.

The determining a hydraulic state by the state estimation model according to the parameters specifically comprises:

solving the hydraulic state estimation model of the steam heating network during dynamic operation established according to the branch equation and the node equation;
calculating steam flow, steam flow velocity, steam density, and steam pressure state for all pipelines according to the state estimation model, i.e., the hydraulic state.

The establishing a branch equation of steam heating pipelines (also referred to as a hydraulic model of steam heating pipelines) includes a specific process of: simplifying steam within the steam heating pipelines to one-dimensional flow along a direction of the pipelines, and establishing a mass-conservation equation thereof:

$$\frac{\partial ρ}{\partial τ} + \frac{\partial ρ v}{\partial x} = 0$$

wherein ρ is steam density, ν is steam flow velocity, τ represents time dimension, and x represents one-dimensional space dimension along the direction of the steam heating pipelines;
to ensure that the mass-conservation equation can be processed on a computer, the partial differential equation is transformed into a difference equation:

$$\frac{( {ρ}_{i . t + 1} - {ρ}_{i , t} ) + ( {ρ}_{j , t + 1} - {ρ}_{j , t} )}{2 Δ t} + \frac{( {ρ}_{i , t} {v}_{i , t} - {ρ}_{j , t} {v}_{j , t} )}{{L}_{i j}} = 0$$

wherein i is a head end of the steam heating pipelines, j is a tail end thereof, ρ_{i,t} represents steam density of node i at time t, ρ_{i,t+1} represents steam density of node i at time t+1, ρ_{j,t} represents steam density of node j at time t, ρ_{j,t+1} represents steam density of node j at time t+1, ν_{i,t} represents steam flow velocity of node i at time t, ν_{j,t} represents steam flow velocity of node j at time t, Δt represents time step, and Lᵢⱼ represents the length of pipeline ij;
simplifying steam within the steam heating pipelines to one-dimensional flow along a direction of the pipelines, and establishing a momentum conservation equation thereof:

$$\frac{\partial ρ v}{\partial t} + \frac{\partial p}{\partial x} + \frac{λ ρ {v}^{2}}{2 D} + ρ g sin α = 0$$

wherein p is steam pressure, λ is pipeline friction coefficient, D is pipeline inner diameter, g is acceleration of gravity, α is pipeline inclination angle, and t is time;
to ensure that the mass-conservation equation can be processed on a computer, the partial differential equation is transformed into a difference equation:

$$\frac{( {ρ}_{i , t + 1} {v}_{i , t + 1} - {ρ}_{i , t} {v}_{i , t} ) + ( {ρ}_{j , t + 1} {v}_{j , t + 1} - {ρ}_{j , t} {v}_{j , t} )}{2 Δ t} + \frac{{p}_{i , t} - {p}_{j , t}}{{L}_{ij}} + \frac{λ ( {ρ}_{i , t} + {ρ}_{j , t} ) {( {v}_{i , t} + {v}_{j , t} )}^{2}}{16 D} + \frac{( {ρ}_{i , t} + {ρ}_{j , t} ) g sin α}{2} = 0$$

wherein p_{i,t} represents steam pressure of node i at time t, p_{j,t} represents steam pressure of node j at time t, ν_{i,t+1} represents steam flow velocity of node i at time t+1, and ν_{j,t+1} represents steam flow velocity of node j at time t+1;
establishing a state equation of steam:

pᵢ=ρᵢRTᵢ

pⱼ=ρⱼRTⱼ

wherein pᵢ is steam pressure at node i, pⱼ is steam pressure at node j, ρᵢ is steam density at node i, ρⱼ is steam density at node j, R is a gas constant fitted by steam nearby operation conditions, Tᵢ is a measured temperature of steam at node i, and Tⱼ is a measured temperature of steam at node j; and
establishing a flow equation of steam within the pipelines:

$${G}_{ij} = \frac{π {D}^{2}}{4} {ρ}_{i} {v}_{i}$$

$${G}_{ji} = \frac{π {D}^{2}}{4} {ρ}_{j} {v}_{j}$$

wherein Gᵢⱼ represents steam flow at a head end of branch ij, Gⱼᵢ represents steam flow at a distal end of branch ij, νᵢ is steam flow velocity at node i, and νⱼ is steam flow velocity at node j.

For the branch equation of each pipeline, the cubic equality constraint is transformed into a bilinear constraint:

$$\frac{( {G}_{i , t + 1} - {G}_{i , t} ) + ( {G}_{j , t + 1} - {G}_{j , t} )}{π {D}^{2} Δ t \text{/} 2} + \frac{{p}_{i , t} - {p}_{j , t}}{{L}_{ij}} + \frac{λ ( {G}_{i , t} {v}_{i , t} + {G}_{j , t} {v}_{j , t} )}{π {D}^{3}} + \frac{( {ρ}_{i , t} + {ρ}_{j , t} ) g sin α}{2} = 0$$

wherein G_{i,t+1} is flow of node i at time t+1, G_{i,t} is flow of node i at time t, G_{j,t+1} is flow of node j at time t+1, G_{j,t} is flow of node j at time t, p_{i,t} represents steam pressure of node i at time t, p_{j,t} represents steam pressure of node j at time t, ν_{i,t} represents steam flow velocity of node i at time t, ν_{j,t} represents steam flow velocity of node j at time t, Δt represents time step, Lᵢⱼ represents the length of pipeline ij, ρ_{i,t} represents steam density of node i at time t, and ρ_{j,t} represents steam density of node j at time t.

The establishing a node equation (also referred to as a topological constraint equation) of junctions of the different steam heating pipelines is:

$${\sum }_{k ∈ {S}_{i}^{+}} {G}_{ki} - {\sum }_{l ∈ {S}_{i}^{-}} {G}_{il} = 0$$

wherein Gₖᵢ represents steam flow from branch ki into node i, Gᵢₗ represents steam flow from branch il into node i, Sᵢ⁺ is a branch set flowing into node i, and Sᵢ⁻ is a branch set flowing out of node i.

A process that the estimating unit is used for establishing a hydraulic state estimation model of a steam heating network during dynamic operation according to the branch equation and the node equation comprises:

establishing an objective function of a hydraulic state estimation model of a steam heating network with a purpose of minimizing mean square error considering covariance:

min(x−\hat{x})^{T}W⁻¹(x−\hat{x})

wherein W represents a covariance matrix consisting of measurement values, x represents a vector consisting of all measurement variables, and i represents a vector consisting of all measurement variables:

x=[p₁, . . . ,p_{N},G₁, . . . ,G_{M}]^{T}

\hat{x}=[\hat{p}₁, . . . ,\hat{p}_{N},Ĝ₁, . . . ,Ĝ_{M}]^{T}

wherein p is actual steam pressure, N is a number of nodes, M is a number of branches, p₁ is actual steam pressure at node 1, p_{N} is actual steam pressure at node N, G₁ is flow of branch 1, G_{M} is flow of branch M, \hat{p}₁ is a sensor sampling value of steam pressure at node 1, \hat{p}_{N} is a sensor sampling value of steam pressure at node N, Ĝ₁ is a sensor sampling value of flow of branch 1, and Ĝ_{M} is a sensor sampling value of branch M.

The solving the hydraulic state estimation model of a steam heating network during dynamic operation established according to the branch equation and the node equation by a hill-climbing method specifically comprises:

S1: fixing all steam flow velocity variables to solve a hydraulic state estimation model of a steam heating network during dynamic operation as a linear programming problem;
S2: fixing steam flow variables solved in S1 to solve a hydraulic state estimation model of a steam heating network during dynamic operation as a linear programming problem; and
S3: checking convergence, solving convergence when a norm of the difference between steam flow inversely deduced from steam flow velocity obtained in S2 according to the steam flow equation and steam flow fixed in advance in S2 is smaller than the given threshold;
returning to S1-S2 to continue iteration when a norm of the difference between steam flow inversely deduced from steam flow velocity obtained in S2 according to the steam flow equation and steam flow fixed in advance in S2 is greater than or equal to the given threshold, wherein S1 and S2 are accomplished by a Cplex or Gurobi commercial solver.

The invention further provides a system for estimating a hydraulic state of a steam heating network during dynamic operation. The system comprising: an acquiring interface unit for acquiring parameters, the parameters including steam flow G, steam flow velocity ν, steam density ρ, steam pressure p, pipeline inner diameter D, pipeline inclination angle α, a number of nodes N, and a number of branches M of each pipeline; an inputting unit for inputting the parameters into a state estimation model constructed thereby, and an estimating unit for determining a hydraulic state by the state estimation model according to the parameters.

The state estimation model in the estimating unit is specifically constructed by:

establishing a branch equation of steam heating pipelines;
establishing a node equation of junctions of the different steam heating pipelines; and
establishing a hydraulic state estimation model of a steam heating network during dynamic operation according to the branch equation and the node equation.

The estimating unit for determining a hydraulic state by a state estimation model according to the parameters specifically comprises: solving the hydraulic state estimation model of a steam heating network during dynamic operation established according to the branch equation and the node equation;

calculating steam flow, steam flow velocity, steam density, and steam pressure state of all pipelines according to the state estimation model, i.e., the hydraulic state.

The establishing a branch equation of steam heating pipelines in the estimating unit specifically comprises:

simplifying steam within the steam heating pipelines to one-dimensional flow along a direction of the pipelines, and establishing a mass-conservation equation thereof:

$$\frac{\partial ρ}{\partial τ} + \frac{\partial ρ v}{\partial x} = 0$$

wherein ρ is steam density, ν is steam flow velocity, τ represents time dimension, and x represents one-dimensional space dimension along a direction of the steam heating pipelines;
simplifying steam within the steam heating pipelines to one-dimensional flow along a direction of the pipelines, and establishing a momentum conservation equation thereof:

$$\frac{\partial ρ v}{\partial t} + \frac{\partial p}{\partial x} + \frac{λρ {v}^{2}}{2 D} + ρ g sin α = 0$$

wherein p is steam pressure, λ is pipeline friction coefficient, D is pipeline inner diameter, g is acceleration of gravity, α is pipeline inclination angle, and t is time;
establishing a state equation of steam:

pᵢ=ρᵢRTᵢ

pⱼ=ρⱼRTⱼ

wherein pᵢ is steam pressure at node i, pⱼ is steam pressure at node j, ρᵢ is steam density at node i, ρⱼ is steam density at node j, R is a gas constant fitted by steam nearby operation conditions, Tᵢ is a measured temperature of steam at node i, and Tⱼ is a measured temperature of steam at node j; and
establishing a flow equation of steam within the pipelines:

$${G}_{ij} = \frac{π {D}^{2}}{4} {ρ}_{i} {v}_{i}$$

$${G}_{ji} = \frac{π {D}^{2}}{4} {ρ}_{j} {v}_{j}$$

wherein Gᵢⱼ represents steam flow at a head end of branch ij, Gⱼᵢ represents steam flow at a distal end of branch ij, νᵢ is steam flow velocity at node i, and νⱼ is steam flow velocity at node j.

The node equation of junctions of the different steam heating pipelines established by the estimating unit is:

$${\sum }_{k ∈ {S}_{i}^{+}} {G}_{ki} - {\sum }_{l ∈ {S}_{i}^{-}} {G}_{il} = 0$$

wherein Gₖᵢ represents steam flow from branch ki into node i, Gᵢₗ represents steam flow from branch il into node i, Sᵢ⁺ is a branch set flowing into node i, and Sᵢ⁻ is a branch set flowing out of node i.

A process that the estimating unit is used for establishing a hydraulic state estimation model of a steam heating network during dynamic operation according to the branch equation and the node equation comprises:

establishing an objective function of a hydraulic state estimation model of a steam heating network with a purpose of minimizing mean square error considering covariance:

min(x−\hat{x})^{T}W⁻¹(x−\hat{x})

wherein W represents a covariance matrix consisting of measurement values, x represents a vector consisting of all measurement variables, and \hat{x} represents a vector consisting of all measurement variables:

x=[p₁, . . . ,p_{N},G₁, . . . ,G_{M}]^{T}

\hat{x}=[\hat{p}₁, . . . ,\hat{p}_{N},Ĝ₁, . . . ,Ĝ_{M}]^{T}

wherein p is actual steam pressure, N is a number of nodes, M is a number of branches, p₁ is actual steam pressure at node 1, p_{N} is actual steam pressure at node N, G₁ is flow of branch 1, G_{M} is flow of branch M, \hat{p}₁ is a sensor sampling value of steam pressure at node 1, \hat{p}_{N} is a sensor sampling value of steam pressure at node N, Ĝ₁ is a sensor sampling value of flow of branch 1, and Ĝ_{M} is a sensor sampling value of branch M.

The solving the hydraulic state estimation model of a steam heating network during dynamic operation established according to the branch equation and the node equation by a hill-climbing method specifically comprises:

S1: fixing all steam flow velocity variables to solve a hydraulic state estimation model of a steam heating network during dynamic operation as a linear programming problem;
S2: fixing steam flow variables solved in S1 to solve a hydraulic state estimation model of a steam heating network during dynamic operation as a linear programming problem; and
S3: checking convergence, solving convergence when a norm of the difference between steam flow inversely deduced from steam flow velocity obtained in S2 according to the steam flow equation and steam flow fixed in advance in S2 is smaller than the given threshold; returning to S1-S2 to continue iteration when a norm of the difference between steam flow inversely deduced from steam flow velocity obtained in S2 according to the steam flow equation and steam flow fixed in advance in S2 is greater than or equal to the given threshold.

Notwithstanding the present invention has been described in detail with reference to the foregoing examples, it should be comprehended by those of ordinary skill in the art that they can still make amendments to the technical solutions recited in the foregoing examples, or equivalently replace part of the technical features thereof; however, such amendments or replacements do not make the essence of the corresponding technical solutions divorced from the spirit and scope of the technical solutions in the examples of the present invention.

1. A method for estimating a hydraulic state of a steam heating network during dynamic operation, wherein the method comprises:
acquiring parameters, the parameters including steam flow G, steam flow velocity ν, steam density ρ, steam pressure p, pipeline inner diameter D, pipeline inclination angle α, a number of nodes N, and a number of branches M of each pipeline;
inputting the parameters into a state estimation model; and
determining a hydraulic state by the state estimation model according to the parameters.

2. The method for estimating a hydraulic state of a steam heating network during dynamic operation according to claim 1, wherein a specific construction method of the state estimation model comprises:
establishing a branch equation of steam heating pipelines;
establishing a node equation of junctions of the different steam heating pipelines; and
establishing a hydraulic state estimation model of the steam heating network during dynamic operation according to the branch equation and the node equation.

3. The method for estimating a hydraulic state of a steam heating network in dynamic operation according to claim 2, wherein the determining a hydraulic state by the state estimation model according to the parameters specifically comprises:
solving the hydraulic state estimation model of the steam heating network during dynamic operation established according to the branch equation and the node equation;
calculating steam flow, steam flow velocity, steam density, and steam pressure state for all pipelines according to the state estimation model.

4. The method for estimating a hydraulic state of a steam heating network during dynamic operation according to claim 2, wherein the establishing a branch equation of steam heating pipelines specifically comprises:
simplifying steam within the steam heating pipelines to one-dimensional flow along a direction of the pipelines, and establishing a mass-conservation equation thereof:
$$\frac{\partial ρ}{\partial τ} + \frac{\partial ρ v}{\partial x} = 0$$
wherein ρ is steam density, ν is steam flow velocity, τ represents time dimension, and x represents one-dimensional space dimension along the direction of the steam heating pipelines;
simplifying steam within the steam heating pipelines to one-dimensional flow along the direction of the pipelines, and establishing a momentum conservation equation thereof:
$$\frac{\partial ρ v}{\partial t} + \frac{\partial p}{\partial x} + \frac{λρ {v}^{2}}{2 D} + ρ g sin α = 0$$
wherein p is steam pressure, λ is pipeline friction coefficient, D is pipeline inner diameter, g is acceleration of gravity, a is pipeline inclination angle, and t is time;
establishing a state equation of steam:
pᵢ=ρᵢRTᵢ
pⱼ=ρⱼRTⱼ
wherein pᵢ is steam pressure at node i, pⱼ is steam pressure at node j, ρᵢ is steam density at node i, ρⱼ is steam density at node j, R is a gas constant fitted by steam nearby operation conditions, Tᵢ is a measured temperature of steam at node i, and Tⱼ is a measured temperature of steam at node j; and
establishing a flow equation of steam within the pipelines:
$${G}_{ij} = \frac{π {D}^{2}}{4} {ρ}_{i} {v}_{i}$$
$${G}_{ji} = \frac{π {D}^{2}}{4} {ρ}_{j} {v}_{j}$$
wherein Gᵢⱼ represents steam flow at a head end of branch ij, Gⱼᵢ represents steam flow at a distal end of branch ij, νᵢ is steam flow velocity at node i, and νⱼ is steam flow velocity at node j.

5. The method for estimating a hydraulic state of a steam heating network during dynamic operation according to claim 2, wherein the establishing a node equation of junctions of the different steam heating pipelines is:
$${\sum }_{k ∈ {S}_{i}^{+}} {G}_{ki} - {\sum }_{l ∈ {S}_{i}^{-}} {G}_{il} = 0$$
wherein Gₖᵢ represents steam flowing from branch ki into node i, Gᵢₗ represents steam flow from branch il into node i, Sᵢ⁺ is a branch set flowing into node i, and Sᵢ⁻ is a branch set flowing out of node i.

6. The method for estimating a hydraulic state of a steam heating network during dynamic operation according to claim 2, wherein the establishing a hydraulic state estimation model of a steam heating network during dynamic operation according to the branch equation and the node equation specifically comprises:
establishing an objective function of a hydraulic state estimation model of a steam heating network with a purpose of minimizing mean square error considering covariance:
min(x−\hat{x})^{T}W⁻¹(x−\hat{x})
wherein W represents a covariance matrix consisting of measurement values, x represents a vector consisting of all measurement variables, and \hat{x} represents a vector consisting of all measurement values:
x=[p₁, . . . ,p_{N},G₁, . . . ,G_{M}]^{T}
\hat{x}=[\hat{p}₁, . . . ,\hat{p}_{N},Ĝ₁, . . . ,Ĝ_{M}]^{T}
wherein p is actual steam pressure, N is a number of nodes, M is a number of branches, p₁ is actual steam pressure at node 1, p_{N} is actual steam pressure at node N, G₁ is flow of branch 1, G_{M} is flow of branch M, \hat{p}₁ is a sensor sampling value of steam pressure at node 1, \hat{p}_{N} is a sensor sampling value of steam pressure at node N, Ĝ₁ is a sensor sampling value of flow of branch 1, and Ĝ_{M} is a sensor sampling value of branch M.

7. The method for estimating a hydraulic state of a steam heating network in dynamic operation according to claim 3, wherein the solving the hydraulic state estimation model of a steam heating network during dynamic operation established according to the branch equation and the node equation specifically comprises:
S1: fixing all steam flow velocity variables to solve a hydraulic state estimation model of a steam heating network during dynamic operation as a linear programming problem;
S2: fixing steam flow variables solved in S1 to solve a hydraulic state estimation model of a steam heating network during dynamic operation as a linear programming problem; and
S3: checking convergence, solving convergence when a norm of the difference between steam flow inversely deduced from steam flow velocity obtained in S2 according to the steam flow equation and steam flow fixed in advance in S2 is smaller than the given threshold;
returning to S1-S2 to continue iteration when a norm of the difference between steam flow inversely deduced from steam flow velocity obtained in S2 according to the steam flow equation and steam flow fixed in advance in S2 is greater than or equal to the given threshold.

8. A system for estimating a hydraulic state of a steam heating network during dynamic operation, wherein the system comprises:
an acquiring unit for acquiring parameters, the parameters including steam flow G, steam flow velocity ν, steam density ρ, steam pressure p, pipeline inner diameter D, pipeline inclination angle α, a number of nodes N, and a number of branches M of each pipeline;
an inputting unit for inputting the parameters into a state estimation model constructed thereby, and an estimating unit for determining a hydraulic state by the state estimation model according to the parameters.

9. The system for estimating a hydraulic state of a steam heating network during dynamic operation according to claim 8, wherein the state estimation model in the estimating unit is specifically constructed by:
establishing a branch equation of steam heating pipelines;
establishing a node equation of junctions of the different steam heating pipelines; and
establishing a hydraulic state estimation model of a steam heating network during dynamic operation according to the branch equation and the node equation.

10. The system for estimating a hydraulic state of a steam heating network during dynamic operation according to claim 9, wherein the estimating unit for determining a hydraulic state by a state estimation model according to the parameters specifically comprises:
solving the hydraulic state estimation model of the steam heating network during dynamic operation established according to the branch equation and the node equation;
calculating steam flow, steam flow velocity, steam density, and steam pressure state of all pipelines according to the state estimation model.

11. The system for estimating a hydraulic state of a steam heating network during dynamic operation according to claim 9, wherein the establishing a branch equation of steam heating pipelines in the estimating unit specifically comprises:
simplifying steam within the steam heating pipelines to one-dimensional flow along a direction of the pipelines, and establishing a mass-conservation equation thereof:
$$\frac{\partial ρ}{\partial τ} + \frac{\partial ρ v}{\partial x} = 0$$
wherein ρ is steam density, ν is steam flow velocity, τ represents time dimension, and x represents one-dimensional space dimension along a direction of the steam heating pipelines;
simplifying steam within the steam heating pipelines to one-dimensional flow along a direction of the pipelines, and establishing a momentum conservation equation thereof:
$$\frac{\partial ρ v}{\partial t} + \frac{\partial p}{\partial x} + \frac{λρ {v}^{2}}{2 D} + ρ g sin α = 0$$
wherein p is steam pressure, λ is pipeline friction coefficient, D is pipeline inner diameter, g is acceleration of gravity, α is pipeline inclination angle, and t is time;
establishing a state equation of steam:
pᵢ=ρᵢRTᵢ
pⱼ=ρⱼRTⱼ
wherein pᵢ is steam pressure at node i, pⱼ is steam pressure at node j, ρᵢ is steam density at node i, ρⱼ is steam density at node j, R is a gas constant fitted by steam nearby operation conditions, Tᵢ is a measured temperature of steam at node i, and Tⱼ is a measured temperature of steam at node j; and
establishing a flow equation of steam within the pipelines:
$${G}_{ij} = \frac{π {D}^{2}}{4} {ρ}_{i} {v}_{i}$$
$${G}_{ji} = \frac{π {D}^{2}}{4} {ρ}_{j} {v}_{j}$$
wherein Gᵢⱼ represents steam flow at a head end of branch ij, Gⱼᵢ represents steam flow at a distal end of branch ij, νᵢ is steam flow velocity at node i, and νⱼ is steam flow velocity at node j.

12. The system for estimating a hydraulic state of a steam heating network during dynamic operation according to claim 9, wherein the node equation of junctions of the different steam heating pipelines established by the estimating unit is:
$${\sum }_{k ∈ {S}_{i}^{+}} {G}_{ki} - {\sum }_{l ∈ {S}_{i}^{-}} {G}_{il} = 0$$
wherein Gₖᵢ represents steam flow from branch ki into node i, Gᵢₗ represents steam flow from branch il into node i, Sᵢ⁺ is a branch set flowing into node i, and Sᵢ⁻ is a branch set flowing out of node i.

13. The system for estimating a hydraulic state of a steam heating network during dynamic operation according to claim 9, wherein a process that the estimating unit is used for establishing a hydraulic state estimation model of a steam heating network during dynamic operation according to the branch equation and the node equation specifically comprises:
establishing an objective function of a hydraulic state estimation model of a steam heating network with a purpose of minimizing mean square error considering covariance:
min(x−\hat{x})^{T}W⁻¹(x−\hat{x})
wherein W represents a covariance matrix consisting of measurement values, x represents a vector consisting of all measurement variables, and \hat{x} represents a vector consisting of all measurement variables:
x=[p₁, . . . ,p_{N},G₁, . . . ,G_{M}]^{T}
\hat{x}=[\hat{p}₁, . . . ,\hat{p}_{N},Ĝ₁, . . . ,Ĝ_{M}]^{T}
wherein p is actual steam pressure, N is a number of nodes, M is a number of branches, p₁ is actual steam pressure at node 1, p_{N} is actual steam pressure at node N, G₁ is flow of branch 1, G_{M} is flow of branch M, \hat{p}₁ is a sensor sampling value of steam pressure at node 1, \hat{p}_{N} is a sensor sampling value of steam pressure at node N, Ĝ₁ is a sensor sampling value of flow of branch 1, and Ĝ_{M} is a sensor sampling value of branch M.

14. The system for estimating a hydraulic state of a steam heating network during dynamic operation according to claim 10, wherein the solving the hydraulic state estimation model of a steam heating network during dynamic operation established according to the branch equation and the node equation by a hill-climbing method specifically comprises:
S1: fixing all steam flow velocity variables to solve a hydraulic state estimation model of a steam heating network during dynamic operation as a linear programming problem;
S2: fixing steam flow variables solved in S1 to solve a hydraulic state estimation model of a steam heating network during dynamic operation as a linear programming problem; and
S3: checking convergence, solving convergence when a norm of the difference between steam flow inversely deduced from steam flow velocity obtained in S2 according to the steam flow equation and steam flow fixed in advance in S2 is smaller than the given threshold;
returning to S1-S2 to continue iteration when a norm of the difference between steam flow inversely deduced from steam flow velocity obtained in S2 according to the steam flow equation and steam flow fixed in advance in S2 is greater than or equal to the given threshold.
